(19) United States
(12) Patent Application Publication
(10) Pub. No.: US 2021/0173720 A1
(43) Pub. Date: Jun. 10, 2021

(54) DYNAMICALLY DIRECT COMPUTE TASKS TO ANY AVAILABLE COMPUTE RESOURCE WITHIN ANY LOCAL COMPUTE CLUSTER OF AN EMBEDDED SYSTEM

(71) Applicant: INTEL CORPORATION, Santa Clara, CA (US)

(72) Inventors: Christopher CORMACK, Portland, OR (US); David J. COWPERTHWAITE, Portland, OR (US); Nicolas GALOPPO VON BORRIES, Portland, OR (US); Janet TSENG, Portland, OR (US); David ZAGE, Livermore, CA (US)

(21) Appl. No.: 17/263,502

(22) PCT Filed: Jul. 31, 2019
(86) PCT No.: PCT/US2019/044503

§ 371 Date: Jan. 26, 2021

Related U.S. Application Data
(60) Provisional application No. 62/714,583, filed on Aug. 3, 2018.

(51) Int. Cl. G06F 9/50

(52) U.S. Cl. CPC G06F 9/5088; G06F 9/5005

(57) ABSTRACT

Apparatuses, methods and storage medium associated with embedded computing, are disclosed herein. In embodiments, an embedded computing platform includes an orchestration scheduler configured to receive live execution telemetry data of various applications executing at the various local compute clusters of the embedded computing platform, as well as the status (availability) of accelerate compute resources of the local compute clusters, and in response, dynamically map selected tasks of applications to any accelerate resource in any of the local compute clusters. The computing platform further includes orchestration agents to respectively collect and provide live execution telemetry data of the applications executing in corresponding ones of the local compute clusters and their resource needs to the orchestration scheduler. Other embodiments are also described and claimed.

This application claims priority to U.S. provisional application Ser. No. 62/714,583, entitled “Dynamically Direct Compute Tasks to Any Available Compute Resource within Any Local Compute Cluster of an Embedded System,” filed on Aug. 3, 2018. The specification of USPA 62/714,583 is hereby fully incorporated by reference.

### TECHNICAL FIELD

The present disclosure relates to the field of computing. More particularly, the present disclosure relates to method and apparatus to dynamically direct compute tasks to any available compute resource within any local compute cluster on an embedded system, such as a computing platform of a computer-assisted or autonomous driving (CA/AD) vehicle, maximizing task acceleration and resource utilization based on the availability, location, and connectivity of the available compute resources.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

As embedded system designs, such as computing platforms of in-vehicle systems, add compute scalability via multi-System on Chip (SoC) architecture (local compute clusters), a problem arises regarding how to make best use of the aggregate compute within the computing platform or system. Multi-SoC systems tend to have multiple, heterogeneous accelerators available to be utilized. Some of these compute resources are internally contained within the SoC itself (e.g. integrated graphics processing unit (GPU), integrated computer vision/deep learning (CV/DL) accelerator (VPU), etc), and some exist outside the SoC as peripheral add-on accelerators over a bus like peripheral component interconnect express (PCIe). In many cases combinations of the above two categories will exist in an embedded system at the same time (multiple internal and external accelerators). Therefore, there might be as an example 3 GPUs in a two-SoC system (2 internal, 1 external).

Balancing the compute of such systems becomes a challenge. There are two general solution paths:
Static provisioning of workloads to specific accelerators, or
Dynamic assignment of workloads to compute resources with available headroom.

In the case of static provisioning, typically entire workloads are provisioned to SoCs with appropriate accelerators/resources. In the case of dynamic scheduling, during runtime, the system does a best effort to “move” entire workloads to a single SoC where appropriate accelerators/resources are available.

Both solutions that exist today work with a granularity of an entire workload, inclusive of the CPU workload as well as all accelerated sub-workloads. Solutions today do not allow “automatic” (transparent to an application developer) recognition of a workload as being made up of tasks of multiple compute classes, with each class being able to be executed on an accelerator peripheral to the SoC where the CPU workload is executing. This means that currently solutions are unable to maximize balance and utilization over all aggregated compute resources in the system.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an overview of an environment for incorporating and using the dynamical direction of compute tasks to any resource technology of the present disclosure, in accordance with various embodiments.

FIG. 2 illustrates a hardware/software view of an example embedded in-vehicle system of FIG. 1 in further details, according to various embodiments.

FIG. 3 illustrates an example process for dynamically directing a compute task to any available resource in any local compute cluster, according to various embodiments.

FIG. 4 illustrates an example computing platform suitable for use to practice aspects of the present disclosure, according to various embodiments.

FIG. 5 illustrates a storage medium having instructions for practicing methods described with references to preceding Figures, according to various embodiments.

### DETAILED DESCRIPTION

To address challenges discussed in the background section, apparatuses, methods and storage medium associated with dynamically directing compute tasks to any available resource within a local compute cluster on an embedded system, such as a computing platform of a vehicle, are disclosed herein. The dynamic direction of compute tasks to any available compute resource technology includes enhanced orchestration solution combined with an interface remoting model, enabling tasks of an application or set of applications of an embedded system to be automatically mapped, e.g., by compute type, across compute resources distributed across the local compute clusters of the embedded system. As a result, better scheduling affinity and granularity, and better system level compute utilization on aggregate across multiple computing resources, in particular, accelerate compute resource, acting as a single system may be achieved.

In various embodiments, an apparatus for embedded computing comprises a plurality of System-on-Chips (SoCs) to form a corresponding plurality of local compute clusters, at least one of the SoCs having accelerate compute resource or resources; an orchestration scheduler to be operated by one of the plurality of SoCs to receive live execution telemetry data of various applications executing at the various local compute clusters and status of accelerate compute resources of the local compute clusters having accelerate compute resources, and in response, dynamically map selected tasks of applications to any accelerate compute resource in any of the local compute clusters having accelerate compute resource(s), based at least in part on the received live execution telemetry data and the status of the accelerate compute resources of the local compute clusters.

In various embodiments, the apparatus further comprises a plurality of orchestration agents to be respectively operated by the plurality of SoCs to collect and provide the live execution telemetry data of the various applications executing at the corresponding ones of the local compute clusters, and the status of the accelerate compute resources of the corresponding ones of the local compute clusters, to the orchestration scheduler.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

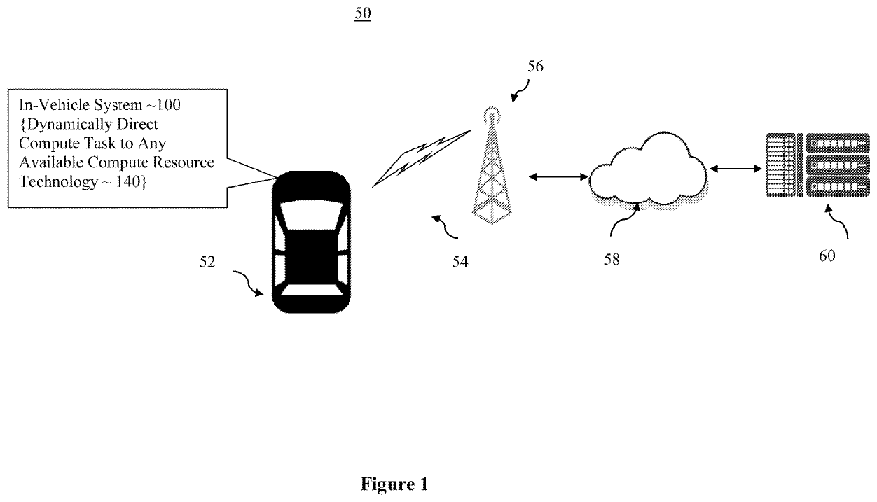

Referring now to FIG. 1, wherein an overview of an environment for incorporating and using the dynamic direction of compute tasks to any compute resource technology of the present disclosure, in accordance with various embodiments, is shown. As illustrated, in various embodiments, example environment 50 includes vehicle 52 having an engine, transmission, axles, wheels and so forth. Further, vehicle 52 includes in-vehicle system (IVS) 100 having computing hardware elements forming a number of local compute clusters (including accelerated compute elements) to host an advanced driving assistance system (ADAS) and a number of infotainment subsystems/applications. The local compute clusters may also be referred to an embedded system or an embedded controller. ADAS may be any one of a number camera-based ADAS with significant image, computer vision (CV) and/or deep learning (DL) computation needs. Examples of infotainment subsystems/applications may include instrument cluster subsystem/applications, front-seat infotainment subsystem/application, such as, a navigation subsystem/application, a media subsystem/application, a vehicle status subsystem/application, a number of rear seat entertainment subsystems/applications, and so forth. Further, IVS 100 is provided with the dynamic direction of compute tasks to any resource technology 140 of the present disclosure, allowing execution of selected tasks of various applications of IVS system 100 to be dynamically directed to any available compute resource, in particular, any available accelerate compute resources, within any local compute cluster on the computing platform of the vehicle.

In various embodiments, IVS system 100, on its own or in response to the user interactions, may communicate or interact with one or more off-vehicle remote content servers 60, via a wireless signal repeater or base station on transmission tower 56 near vehicle 52, and one or more private and/or public wired and/or wireless networks 58. Examples of private and/or public wired and/or wireless networks 58 may include the Internet, the network of a cellular service provider, and so forth. It is to be understood that transmission tower 56 may be different towers at different times/locations, as vehicle 52 en routes to its destination.

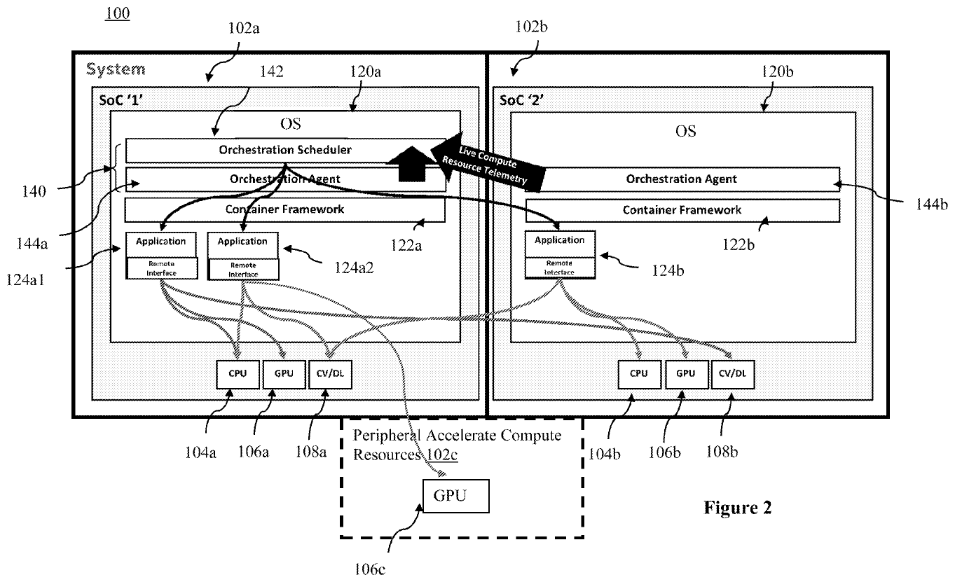

Referring now FIG. 2, wherein a hardware/software view of an example embedded in-vehicle system of FIG. 1 having the dynamic direction of compute tasks to any compute resource technology, according to various embodiments, is shown in further details. As illustrated, for the example embodiments, in-vehicle system 100 includes a computing platform having hardware 102*-108*, and software 120*-124* and 140 (including 142 and 144*) (* denotes subscripts a, b, et al). Hardware 102*-108* include SoC1 102a and SoC2 102b. Each of SoC1/SoC2 102a/102b includes central processing unit (CPU) 104a/104b, graphics processing unit (GPU) 106a/106b, and accelerators 108a/108b (such as computer vision/deep learning (CV/DL) accelerators. Software 120*-124* and 140 include operating systems (OS) 120a and 120b respectively hosted by SoC1 102a and SoC 102b. Each OS 120a/120b host execution of a container framework 122a/122b and applications 124a/124b. Each application 124* may include one or more interfaces that can be mapped to remote compute resources, e.g., to corresponding device drivers of the remote compute resources. Each SoC1/SoC2 102a/102b is also referred to as a local compute cluster. In other embodiments, each of SoC1/SoC2 102a/102b may include other accelerators.

Continuing to refer to FIG. 2, the computing platform 100 is also provided with the dynamic direction of compute tasks to any compute resource technology 140 of the present disclosure, which includes orchestration scheduler 142, and orchestration agents 144a and 144b, one per OS environment of a local compute cluster. For the illustrated embodiments, orchestration scheduler 142 is hosted by SoC1 102a/OS 120a. In alternate embodiments, orchestration scheduler 142 may be hosted by any SoC/OS. Orchestration scheduler 142 is configured to selectively map compute tasks to any available compute resources, in particular accelerated compute resources in any of the local compute clusters. Orchestration scheduler 142 is configured to automatically recognize tasks of an application 124a*/124b as tasks of different compute classes, some of which may be accelerate compute class. Orchestration scheduler 142 is further configured to receive live execution telemetry data on the execution of the various applications 124a*/124b at the various local compute clusters, as well as the status (availability) of the compute resources (such as CPU 104*, GPU 106* and CV/DL accelerators 108a/108b) of the local compute clusters. In response, orchestration scheduler 142 dynamically maps the tasks of various compute classes of applications 124a*/124b to any of the available resources, such as CPU 104*, GPU 106*, CV/DV accelerators 108a/108b in either SoC1 102a or SoC2 102b. In some embodiments, the tasks of various compute classes of applications 124a*/124b may be mapped for foreground or background execution.

Orchestration agents 144a and 144b, respectively hosted by OS 120a and 120b, are configured to cooperate with orchestration scheduler 142 to collect and provide live execution telemetry data on the execution of applications 124a* and 124a and their resource needs, as well as their scheduling to use CPU 104*, GPU 106*, CV/DV accelerators 108a/108b or other accelerators (such as GPU 106c, to be described more fully below). In embodiments, the live execution telemetry data may be collected from the various compute resources, CPU 104a/104b, GPU 106a/106b, CV/DL accelerators 108a/108b and so forth. In embodiments, the resource needs of applications 124a* and 124b may be seeded in applications 124a* and 124b by the applications developers. For example, the resource needs may be seeded in control sections of applications 124a* and 124b. In embodiments, orchestration agents 144a and 144b (or orchestration scheduler 140) may contact a remote cloud server (such as cloud server 60 of FIG. 1) for the resource needs of an application 124a*/124b. Communications between orchestration agents 144a and 144b and OS 120a and 120b, and orchestration scheduler 142 may be exchanged in any one of a number of known inter-process communication techniques.

Still referring to FIG. 2, in various embodiments, IVS 100 may further include one or more optional peripheral accelerate compute resources 102c (as depicted by the dash line box), such as GPU 106c. Peripheral accelerate compute resources 102c may be coupled to SoC 102* via one or more system bus, e.g., one or more PCIe buses. For these embodiments, orchestration scheduler 142 is further arranged to include peripheral accelerate compute resources 102c among the any candidate compute resources for consideration in scheduling tasks of applications 124a*/124b. Similarly, orchestration scheduler 142 may be further arranged to selectively map tasks of application 124a*/124b to execute on peripheral accelerate compute resources 102c based at least in part on resource needs of applications 124a*/124b, availability of peripheral accelerate compute resources 102c, live execution telemetry data of applications 124a*/124b, and so forth. In various embodiments, a selected one of orchestration agents 144a/144b may be further arranged to collect and provide the live execution telemetry data of tasks executing on peripheral accelerate compute resources 102c.

As non-limiting examples, for the illustrated embodiments of FIG. 2, various tasks of application 124a1 within container framework 122a are mapped to execute on CPU 104a and GPU 106a within the local compute cluster of SoC1, and other tasks are mapped to execute in CV/DL 108b within the local compute cluster of SoC2. Illustrated also are various tasks of application 124a2 within container framework 122a are mapped to execute on CPU 104a and CV/DL 108a within the local compute cluster of SoC1, and other tasks are mapped to execute in GPU 106c within peripheral accelerate compute resources 102c. Further illustrated are various tasks of application 124b within container framework 122b are mapped to execute on CPU 104b and GPU 106b within the local compute cluster of SoC2, and other tasks are mapped to execute in CV/DL 108a within the local compute cluster of SoC1. It should be noted that for ease of understanding, the tasks of applications 124a*/124b are illustrated as being mapped to execute on one CPU 104*, one GPU 106* and one CV/DL accelerator 108*, the present disclosure is not so limited, different tasks of applications 124a*/124b may be mapped to execute multiple ones of CPU 104*, multiple ones of GPU 106* and/or multiple one CV/DL accelerator 108*, Except for the dynamic direction of compute tasks to any compute resource technology 140 provided, SoC1 and SoC2 102a and 102b, including CPU 104a and 104b, GPU 106a and 106b and CV/DV accelerators 108a and 108, and optional peripheral accelerate compute resources 102c may be any one of these elements known in the art. For examples, SoC 102* may be an Atom platforms from Intel Corporation of Santa Clara, Calif. Similarly, OS 120a and 120b, container frameworks 122a and 122b, and applications 124a* and 124b may likewise be any one of these elements known in the art. For example. OS 120* may be a Linux OS available from Ubuntu of London, UK. Examples of applications 124a*-124b may include, but are not limited to, instrument cluster subsystem/applications, front-seat infotainment subsystem/application, such as, a navigation subsystem/application, a media subsystem/application, a vehicle status subsystem/application, a number of rear seat entertainment subsystems/applications, and so forth.

Further, it should be noted, while for ease of understanding, only two SoCs 102a and 102b are shown, and each having one CPU 104a/104b, one GPU 106a/106b and one CV/DL accelerator 108a/108b, the disclosure is not so limited. The dynamic direction of compute tasks to any compute resource technology of the present disclosure may be provided to computing platform with more than 2 SoCs, each having one or more CPUs, one or more GPUs, and/or one or more CV/DL accelerators, as well as other peripheral accelerators. For example, the computing platform may have further resources (e.g., hardware security module or FPGA) that can be incorporated and mapped to, as part of the accelerate compute orchestration. As earlier described, the peripheral accelerate compute resources, such as peripheral GPU, CV/DL accelerators may be connected to the SoCs via standard high speed interfaces (e.g. PCIe, USB, etc). In addition, the SoCs are not required to be identical (e.g., SoC1 has CV/DL accelerators while SoC #2 has none.) Similarly, the included compute resources are also not required to be identical, e.g., the CPUs, the GPUs, and/or the CV/DL accelerators, within and/or outside the SoCs, may be of different designs/architectures, i.e., heterogeneous.

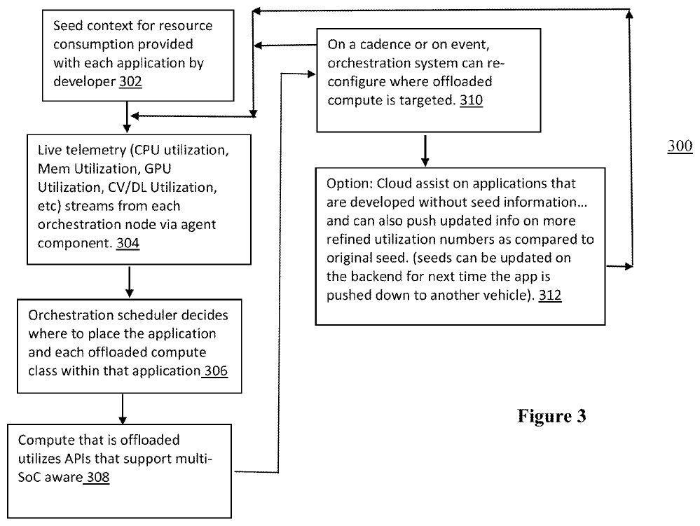

Referring now to FIG. 3, wherein a process for accelerate compute orchestration, according to various embodiments, are shown. As illustrated process 300 for dynamically mapping (potentially accelerated) compute task to any resource in any local compute node of a computing platform of an in-vehicle system includes operations performed at blocks 302-310.

Process 300 starts at block 302. At block 302, context for resource consumption may be seeded/provided to each application by the application developer. At block 304, live execution telemetry data (CPU utilization, memory utilization, GPU utilization, CV/DL accelerators utilization, etc.) are streamed to the orchestration scheduler from each local compute cluster (which may also be referred to as compute nodes) via the corresponding orchestration agent. The compute resource needs may also be retrieved from the applications (or obtained from a remote cloud server) by the orchestration agents, and provided to the orchestration scheduler.

At block 306, orchestration scheduler analyzes the application for remotable compute tasks/classes, and decides where to direct the application and each remotable compute task/class within that application, for execution. In some embodiments, orchestration scheduler may recognize the remotable compute classes, in accordance with control information seeded in the control sections of the applications, or control information retrieved from a remote application cloud server. In various embodiments, the mapping/directing decision, in addition to the resource needs of the applications (i.e., their tasks), may also be based on the available of the compute resources in the various SoCs, peripheral compute resources, and/or resource utilization histories of the applications/tasks. At block 308, compute tasks that are mapped/offloaded utilize various application programming interfaces (API) that are multi-SoC aware to remote their execution, and report their execution results. Examples of API that are multi-SoC aware include, but are not limited to, REST, OpenGL for GPU, and OpenCV for CV.

In addition to compute task specification (as defined by compute task APIs), directing compute tasks to any available resource in an embedded computing platform may also require data transfer and/or sharing between SoCs & peripheral compute resources on the embedded computing platform. The data that needs to be accessed by the targeted compute resource can be local (e.g. when it shares physical memory with the SoC/component that owns the data), or remote (e.g. across multiple discrete components, compute resources, or SoCs, each with their own physical memory regions). Whether local or remote, the transfer of data between compute components can be optimized to minimize traffic between components, and can be made transparent through the use of a common data sharing API. Further, the data transfer requirements can contribute to the soft constraints of the dynamic scheduling process (orchestration). During execution, the orchestration agents may respectively report the execution telemetry data of the applications/tasks, and/or statuses (availability) of the resources of the SoCs (and/or peripheral compute resources) to the orchestration scheduler.

At block 310, on a cadence or on event, the orchestration scheduler can re-configure where offloaded compute is targeted. From block 310, process 300 may return to block 304 and continue therefrom as earlier described, or proceed to optional block 312, before returning to block 304. At optional block 312, orchestration scheduler may contact a cloud server for accelerate (and/or non-accelerate (standard)) compute needs for applications not seeded with such information, or updates to the accelerate (and/or non-accelerate (standard)) compute needs seeded. Further, local execution telemetry data gathered during system operation can be used to update local application context and resource consumption, enabling better dynamically directed compute task placement, in particular, accelerate compute task placement The system gains a better understanding of how the applications are affected by local versus remote access to compute resources and function in deployed environments.

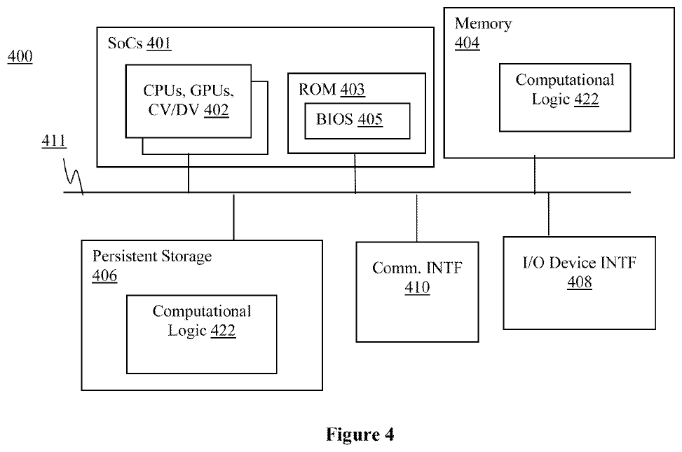

FIG. 4 illustrates an example computing platform that may be suitable for use to practice selected aspects of the present disclosure. As shown, computing platform 400 may include one or more SoCs 401. Each SoC 401 may include one or more CPUs, GPUs, CV/DV or other accelerators 402, and read-only memory (ROM) 403. CPUs, GPUs and CV/DL accelerators 402 may be any one of a number of CPUs, GPUs and accelerators known in the art. Similarly, ROM 403 may be any one of a number of ROM known in the art. Computing platform 400 may also include system memory 404, which may likewise be any one of a number of volatile storage known in the art.

Additionally, computing system 400 may include persistent storage devices 406. Example of persistent storage devices 406 may include, but are not limited to, flash drives, hard drives, compact disc read-only memory (CD-ROM) and so forth. Further, computer system 400 may include input/output devices 408 (such as display, keyboard, cursor control and so forth) and communication interfaces 410 (such as network interface cards, modems and so forth). The elements may be coupled to each other via system bus 412, which may represent one or more buses. In the case of multiple buses, they may be bridged by one or more bus bridges (not shown).

Each of these elements may perform its conventional functions known in the art.

In particular, ROM 403 may include basic input/output system services (BIOS) 405 having a boot loader. System memory 404 and mass storage devices 406 may be employed to store a working copy and a permanent copy of the programming instructions implementing the operations associated with OS 120a/120b, container frameworks 122a/122b, orchestration scheduler 142 and/or orchestration agents 144a/144b, collectively referred to as computational logic 422. The various elements may be implemented by assembler instructions supported by CPUs 402 or high-level languages, such as, for example, C, that can be compiled into such instructions.

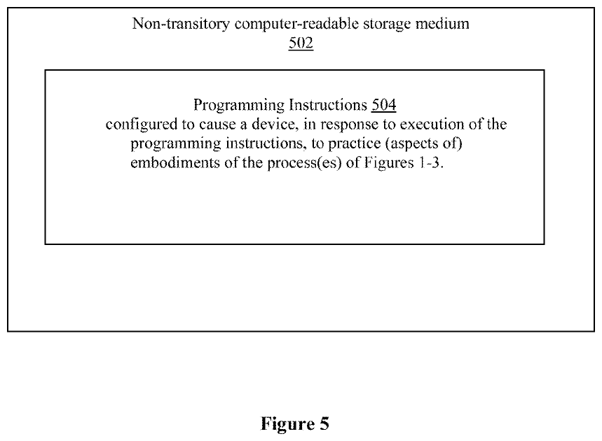

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 5 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 502 may include a number of programming instructions 504. Programming instructions 504 may be configured to enable a device, e.g., computing platform 400, in response to execution of the programming instructions, to implement (aspects of) OS 120a/120b, container frameworks 122a/122b, orchestration scheduler 142 and/or orchestration agents 144a/144b. In alternate embodiments, programming instructions 504 may be disposed on multiple computer-readable non-transitory storage media 502 instead. In still other embodiments, programming instructions 504 may be disposed on computer-readable transitory storage media 502, such as, signals.

Thus, example embodiments described include: Example 1 is An apparatus for computing, comprising: a plurality of System-on-Chips (SoCs) to form a corresponding plurality of local compute clusters, at least one of the SoCs having accelerate compute resource or resources; an orchestration scheduler to be operated by one of the plurality of SoCs to receive live execution telemetry data of various applications executing at the various local compute clusters and status of accelerate compute resources of the local compute clusters having accelerate compute resources, and in response, dynamically map selected tasks of applications to any accelerate compute resource in any of the local compute clusters having accelerate compute resource(s), based at least in part on the received live execution telemetry data and the status of the accelerate compute resources of the local compute clusters.

Example 2 is example 1, wherein the orchestration scheduler is further arranged to map other tasks of applications to any non-accelerate compute resource in any of the local compute clusters, the SoCs further respectively having non-accelerate compute resources.

Example 3 is example 1, further comprising a plurality of orchestration agents to be respectively operated by the plurality of SoCs to collect and provide the live execution telemetry data of the various applications executing at the corresponding ones of the local compute clusters, and the status of the accelerate compute resources of the corresponding ones of the local compute clusters, to the orchestration scheduler.

Example 4 is example 3, wherein the plurality of orchestration agents are further arranged to respectively provide status of other compute resources of the corresponding ones of the local compute clusters, to the orchestration scheduler.

Example 5 is example 3, wherein the plurality of orchestration agents are further arranged to respectively provide resource needs of the applications executing on the corresponding ones of the local compute clusters to the orchestration scheduler.

Example 6 is example 1 further comprises a peripheral accelerate compute resource coupled to one or more of the SoCs; wherein the orchestration scheduler is further arranged to receive status of the peripheral accelerate compute resource, and in response, dynamically map tasks of applications to the peripheral accelerate compute resource.

Example 7 is example 6, further comprising a plurality of orchestration agents to be respectively operated by the plurality of SoCs to collect and provide the live execution telemetry data of the various applications executing at the corresponding ones of the local compute clusters, and the status of the accelerate compute resources of the corresponding ones of the local compute clusters and the peripheral accelerate compute resource, to the orchestration scheduler.

Example 8 is example 6, wherein the peripheral accelerate compute resource comprises a graphics processing unit (GPU).

Example 9 is example 1, wherein at least one of the accelerate compute resources of at least one of the SoCs includes a computer vision or deep learning (CV/DL) accelerator.

Example 10 is example 1, wherein each of the SoCs further includes a central processing unit (CPU), and at least one of the accelerate compute resources of at least one of the SoCs includes a graphics processing unit (GPU).

Example 11 is example 10, wherein a plurality of the SoCs respectively include accelerate compute resources, and wherein at least two of the accelerate compute resources are accelerate compute resources of different types or designs.

Example 12 is any one of examples 1-11, wherein the apparatus is an embedded system, part of an in-vehicle system, of a computer-assisted/autonomous driving (CA/AD) vehicle.

Example 13 is a method for computing, comprising: receiving, by an orchestration scheduler of an embedded system, live execution telemetry data of various applications executing in local compute clusters of and status of accelerate compute resources of the local compute clusters, from respective orchestration agents disposed at the local compute clusters, the embedded system having a plurality of System-on-Chips (SoCs) respectively forming the local compute clusters, the plurality of orchestration agents being correspondingly associated with the local computer clusters, and the SoCs having accelerate compute resources; deciding, by the orchestration scheduler, which one of the accelerate compute resources of the local compute clusters to map a task of an application for execution; and mapping, by a corresponding one of the orchestration agents, execution of the task of the application at the accelerate compute resource of the local compute cluster decided by the orchestration scheduler.

Example 14 is example 13, further comprising deciding, by the orchestration scheduler, which non-accelerate compute resource of the local compute clusters other tasks of the applications are to be mapped for execution, the SoCs further respectively having non-accelerate compute resources.

Example 15 is example 13, further comprising respectively providing, by the orchestration agents, status of other compute resources of the corresponding ones of the local compute clusters, to the orchestration scheduler, the SoCs further having other compute resources.

Example 16 is example 13, further comprising respectively providing, by the orchestration agents, resource needs of the applications executing on the corresponding ones of the local compute clusters to the orchestration scheduler.

Example 17 is example 16, further comprising contacting by the orchestration scheduler or an orchestration agent, a cloud server for accelerate compute needs of the application, or updates to the accelerate compute needs of the application.

Example 18 is example 13, wherein the embedded system further comprises a peripheral accelerate compute resource coupled to the plurality of SoCs; wherein receiving further comprises receiving status of the peripheral accelerate compute resource; and wherein deciding comprises deciding whether to map the task of application to execute on the peripheral accelerate compute resource.

Example 19 is any one of examples 13-18, wherein receiving, deciding and scheduling by the orchestration scheduler and the orchestration agents on the embedded system comprise receiving, deciding and mapping by the orchestration scheduler and the orchestration agents in an in-vehicle system of a computer-assisted/autonomous driving (CA/AD) vehicle.

Example 20 is at least one computer-readable medium (CRM) having instructions stored therein, to cause an embedded system, in response to execution of the instruction by the embedded system, to operate a plurality of orchestration agents in a plurality of local compute clusters formed with a plurality of corresponding System-of-Chips (SoCs): wherein the plurality of orchestration agents provide to an orchestration scheduler of the embedded system, live execution telemetry data of various applications executing at the corresponding local compute clusters, and status of accelerate compute resources of the local compute clusters; and wherein the status of the accelerate compute resources of the local compute clusters are used by the orchestration scheduler to map a task of an application to execute in a selected one of the accelerate compute resources of the local compute clusters.

Example 21 is example 20, wherein the orchestration agent further provides status of other compute resources of the corresponding ones of the local compute clusters, to the orchestration scheduler, the corresponding SoC further having other compute resources.

Example 22 is example 20, wherein a corresponding one of the orchestration agents further provides resource needs of the application to the orchestration scheduler.

Example 23 is example 22, wherein the corresponding one of the orchestration agents further contacts a cloud server for accelerate compute needs of the application, or updates to the accelerate compute needs of the application.

Example 24 is example 20, wherein the embedded system further comprises a peripheral accelerate compute resource coupled to the plurality of SoCs; wherein the orchestration agents further provide status of the peripheral accelerate compute resource to the orchestration scheduler; and wherein the orchestration scheduler is further arranged to decide whether to schedule the task of the application to execute on the peripheral accelerate compute resource.

Example 25 is any one of examples 20-24, wherein the embedded system is part of an in-vehicle system of a computer-assisted/autonomous driving (CA/AD) vehicle.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server.

In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof. Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

1. An apparatus for computing, comprising:
a plurality of System-on-Chips (SoCs) to form a corresponding plurality of local compute clusters, at least one of the SoCs having accelerate compute resource or resources;
an orchestration scheduler to be operated by one of the plurality of SoCs to receive live execution telemetry data of various applications executing at the various local compute clusters and status of accelerate compute resources of the local compute clusters having accelerate compute resources, and in response, dynamically map selected tasks of applications to any accelerate compute resource in any of the local compute clusters having accelerate compute resource(s), based at least in part on the received live execution telemetry data and the status of the accelerate compute resources of the local compute clusters.

2. The apparatus of claim 1, wherein the orchestration scheduler is further arranged to map other tasks of applications to any non-accelerate compute resource in any of the local compute clusters, the SoCs further respectively having non-accelerate compute resources.

3. The apparatus of claim 1, further comprising a plurality of orchestration agents to be respectively operated by the plurality of SoCs to collect and provide the live execution telemetry data of the various applications executing at the corresponding ones of the local compute clusters, and the status of the accelerate compute resources of the corresponding ones of the local compute clusters, to the orchestration scheduler.

4. The apparatus of claim 3, wherein the plurality of orchestration agents are further arranged to respectively provide status of other compute resources of the corresponding ones of the local compute clusters, to the orchestration scheduler.

5. The apparatus of claim 3, wherein the plurality of orchestration agents are further arranged to respectively provide resource needs of the applications executing on the corresponding ones of the local compute clusters to the orchestration scheduler.

6. The apparatus of claim 1 further comprises a peripheral accelerate compute resource coupled to one or more of the SoC; wherein the orchestration scheduler is further arranged to receive status of the peripheral accelerate compute resource, and in response, dynamically map tasks of applications to the peripheral accelerate compute resource.

7. The apparatus of claim 6, further comprising a plurality of orchestration agents to be respectively operated by the plurality of SoCs to collect and provide the live execution telemetry data of the various applications executing at the corresponding ones of the local compute clusters, and the status of the accelerate compute resources of the corresponding ones of the local compute clusters and the peripheral accelerate compute resource, to the orchestration scheduler.

8. The apparatus of claim 6, wherein the peripheral accelerate compute resource comprises a graphics processing unit (GPU).

9. The apparatus of claim 1, wherein at least one of the accelerate compute resources of at least one of the SoCs includes a computer vision or deep learning (CV/DL) accelerator.

10. The apparatus of claim 1, wherein each of the SoCs further includes a central processing unit (CPU), and at least one of the accelerate compute resources of at least one of the SoCs includes a graphics processing unit (GPU).

11. The apparatus of claim 10, wherein a plurality of the SoCs respectively include accelerate compute resources, and wherein at least two of the accelerate compute resources are accelerate compute resources of different types or designs.

12. The apparatus of claim 1, wherein the apparatus is an embedded system, part of an in-vehicle system, of a computer-assisted/autonomous driving (CA/AD) vehicle.

13. A method for computing, comprising:
receiving, by an orchestration scheduler of an embedded system, live execution telemetry data of various applications executing in local compute clusters of and status of accelerate compute resources of the local compute clusters, from respective orchestration agents disposed at the local compute clusters, the embedded system having a plurality of System-on-Chips (SoCs) respectively forming the local compute clusters, the plurality of orchestration agents being correspondingly associated with the local computer clusters, and the SoCs having accelerate compute resources;
deciding, by the orchestration scheduler, which one of the accelerate compute resources of the local compute clusters to map a task of an application for execution; and
mapping, by a corresponding one of the orchestration agents, execution of the task of the application at the accelerate compute resource of the local compute cluster decided by the orchestration scheduler.

14. The method of claim 13, further comprising deciding, by the orchestration scheduler, which non-accelerate compute resource of the local compute clusters other tasks of the applications are to be mapped for execution, the SoCs further respectively having non-accelerate compute resources.

15. The method of claim 13, further comprising respectively providing, by the orchestration agents, status of other compute resources of the corresponding ones of the local compute clusters, to the orchestration scheduler, the SoCs further having other compute resources.

16. The method of claim 13, further comprising respectively providing, by the orchestration agents, resource needs of the applications executing on the corresponding ones of the local compute clusters to the orchestration scheduler.

17. The method of claim 16, further comprising contacting by the orchestration scheduler or an orchestration agent, a cloud server for accelerate compute needs of the application, or updates to the accelerate compute needs of the application.

18. The method of claim 13, wherein the embedded system further comprises a peripheral accelerate compute resource coupled to the plurality of SoCs; wherein receiving further comprises receiving status of the peripheral accelerate compute resource; and wherein deciding comprises deciding whether to map the task of application to execute on the peripheral accelerate compute resource.

19. The method of claim 13, wherein receiving, deciding and scheduling by the orchestration scheduler and the orchestration agents on the embedded system comprise receiving, deciding and mapping by the orchestration scheduler and the orchestration agents in an in-vehicle system of a computer-assisted/autonomous driving (CA/AD) vehicle.

20. At least one computer-readable medium (CRM) having instructions stored therein, to cause an embedded system, in response to execution of the instruction by the embedded system, to operate a plurality of orchestration agents in a plurality of local compute clusters formed with a plurality of corresponding System-of-Chips (SoCs):
wherein the plurality of orchestration agents provide to an orchestration scheduler of the embedded system, live execution telemetry data of various applications executing at the corresponding local compute clusters, and status of accelerate compute resources of the local compute clusters; and
wherein the status of the accelerate compute resources of the local compute clusters are used by the orchestration scheduler to map a task of an application to execute in a selected one of the accelerate compute resources of the local compute clusters.

21. The CRM of claim 20, wherein the orchestration agent further provides status of other compute resources of the corresponding ones of the local compute clusters, to the orchestration scheduler, the corresponding SoC further having other compute resources.

22. The CRM of claim 20, wherein a corresponding one of the orchestration agents further provides resource needs of the application to the orchestration scheduler.

23. The CRM of claim 22, wherein the corresponding one of the orchestration agents further contacts a cloud server for accelerate compute needs of the application, or updates to the accelerate compute needs of the application.

24. The CRM of claim 20, wherein the embedded system further comprises a peripheral accelerate compute resource coupled to the plurality of SoCs; wherein the orchestration agents further provide status of the peripheral accelerate compute resource to the orchestration scheduler; and wherein the orchestration scheduler is further arranged to decide whether to schedule the task of the application to execute on the peripheral accelerate compute resource.

25. The CRM of claim 20, wherein the embedded system is part of an in-vehicle system of a computer-assisted/autonomous driving (CA/AD) vehicle.
